(19) United States
(12) Patent Application Publication
(10) Pub. No.: US 2014/0284444 A1
(43) Pub. Date: Sep. 25, 2014

(54) Rotatable Easel with Adjustable Arms

(71) Applicants: Charles Young, Mukilteo, WA (US); Joseph Park, Seattle, WA (US)

(72) Inventors: Charles Young, Mukilteo, WA (US); Joseph Park, Seattle, WA (US)

(21) Appl. No.: 13/944,818

(22) Filed: Jul. 17, 2013

Related U.S. Application Data
(60) Provisional application No. 61/674,049, filed on Jul. 20, 2012.

(51) Int. Cl. A47B 97/04; F16M 13/00

(52) U.S. Cl. CPC A47B 97/04; F16M 13/00
USPC 248/448; 248/451

(57) ABSTRACT

An apparatus for supporting and/or positioning two-dimensional objects is described. In some examples, the apparatus is an easel configured to position a canvas in front of a painter in any orientation within three-dimensional space. Such an easel enables a painter working with the canvas to adjust and/or orient the canvas with respect to the painter, such as by rotating the canvas towards or away from the painter, rotating the canvas about itself, translating the canvas vertically, translating the canvas horizontally, and so on.

### CROSS REFERENCE TO RELATED APPLICATIONS

This application claims priority to U.S. Provisional Patent Application No. 61/674,049, filed on Jul. 20, 2012, entitled ROTATABLE EASEL WITH ADJUSTABLE ARMS, which is hereby incorporated by reference in its entirety.

### BACKGROUND

Artists often act as inventors. They, or the people working with them, attempt to create works of art that realize a certain aesthetic or form, and in doing so, create objects that provide functionality and utility. Roy Lichtenstein, for example, created a rotating easel to help him observe a painting in any direction. Naturally, many artists employ rotating easels when painting.

### BRIEF DESCRIPTION OF THE DRAWINGS

FIG. 1 is a schematic diagram of a rotatable easel.

FIG. 2A is a schematic diagram of an attachment mechanism of a rotatable easel.

FIG. 2B is a schematic diagram of an arm of an attachment mechanism in a shortened position.

FIG. 3 is a schematic diagram of a grip component of an attachment mechanism.

### DETAILED DESCRIPTION

### Overview

An apparatus for supporting and/or positioning two-dimensional objects is described. In some examples, the apparatus is an easel configured to position a canvas in front of a painter in any orientation within three-dimensional space. Such an easel enables a painter working with the canvas to adjust and/or orient the canvas with respect to the painter, such as by rotating the canvas towards or away from the painter, rotating the canvas about itself, translating the canvas vertically, translating the canvas horizontally, and so on.

In some examples, the apparatus includes an attachment mechanism configured to receive and fix canvasses of many different sizes to the apparatus. The attachment mechanism may include two or more arms that intersect with one another and act as a platform in which to locate a canvas. The arms may include telescopic components that slide relative to another in order to shorten or lengthen the arms. A grip or holding piece may be located at the ends of each of the arms in order to receive and hold a canvas in place on or proximate to the arms of the attachment mechanism.

The apparatus will now be described with respect to various embodiments, examples, and/or implementations. The following description provides specific details for a thorough understanding of, and enabling description for, these embodiments of the apparatus. However, one skilled in the art will understand that the apparatus may be configured without these details. In other instances, well-known structures have not been shown or described in detail to avoid unnecessarily obscuring the description of the embodiments of the apparatus.

It is intended that the terminology used in the description presented below be interpreted in its broadest reasonable manner, even though it is being used in conjunction with a detailed description of certain specific embodiments of the apparatus. Certain terms may even be emphasized below; however, any terminology intended to be interpreted in any restricted manner will be overtly and specifically defined as such in this Detailed Description section.

### Suitable System

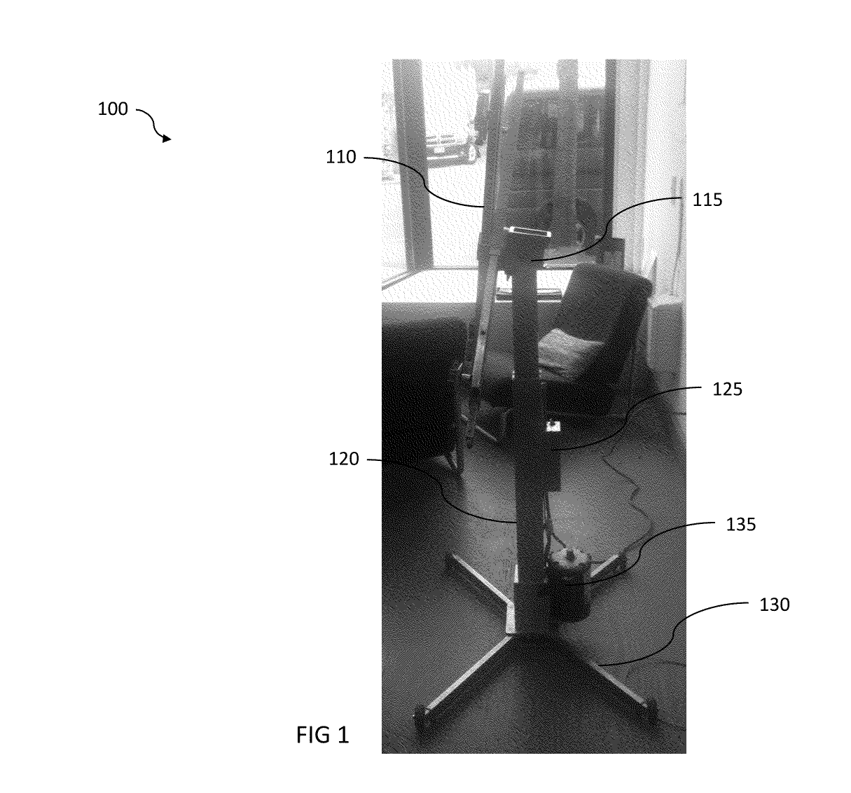

As described herein, in some examples, an easel configured to support and/or position a canvas in three-dimensional space is described. FIG. 1 is a schematic diagram of a rotatable easel 100. The easel 100 includes an attachment mechanism 110 that supports a canvas or other relatively two-dimensional object (e.g., a whiteboard, a display screen, a sign, and so on). The attachment mechanism is coupled to a support beam 120 and base 130 via an orientation component 115, which is configured to allow the attachment mechanism 110, and any object being held by the attachment mechanism 110, to rotate and/or revolve in any direction within three-dimensional space.

The support beam 120 may include one or more beams capable of translating in a vertical direction, any may include a translation component 125 that causes the support beam to move upwards or downwards when a motor 135 or other source of energy, coupled to the translation component 125, is utilized. The base 130 may include legs, wheels, or other components that maintain the support beam 120 in a vertical position with respect to a surface on which the easel 100 is placed.

Thus, the easel 100 includes components configured to dynamically adjust an orientation of an object supported and positioned by the easel 100 in a vertical direction (via support beam 120 and translation component 125), in a direction of rotation toward or away from a person proximate to the easel (via the orientation component 115), in a direction that rotates about an axis provided by and parallel to the support beam (via the orientation component 115), about an axis perpendicular to the support beam, and so on.

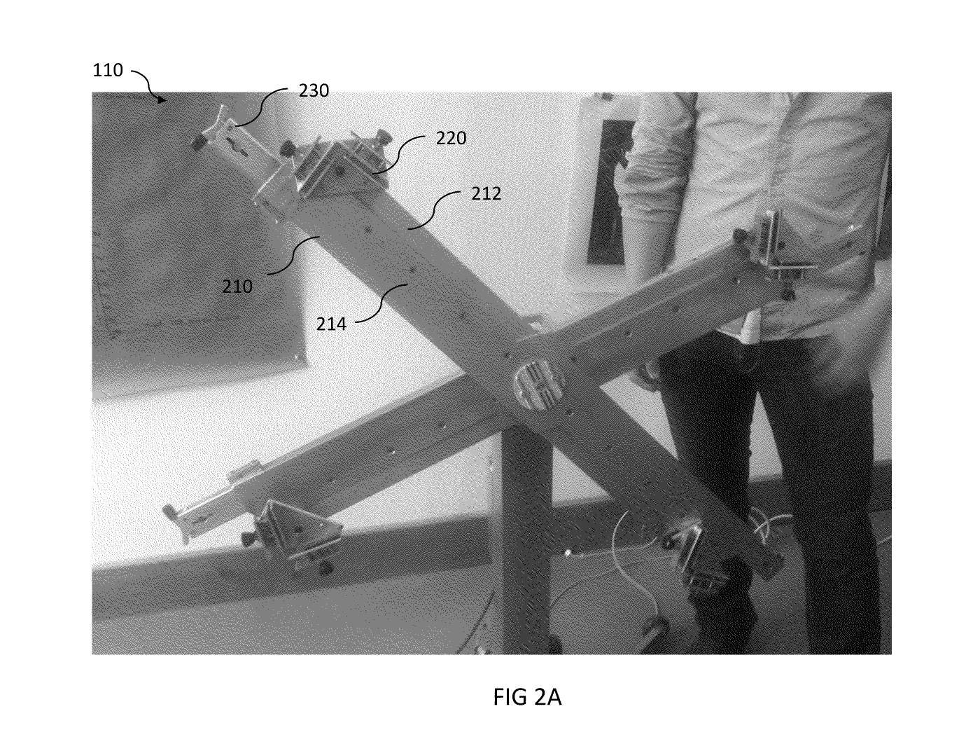

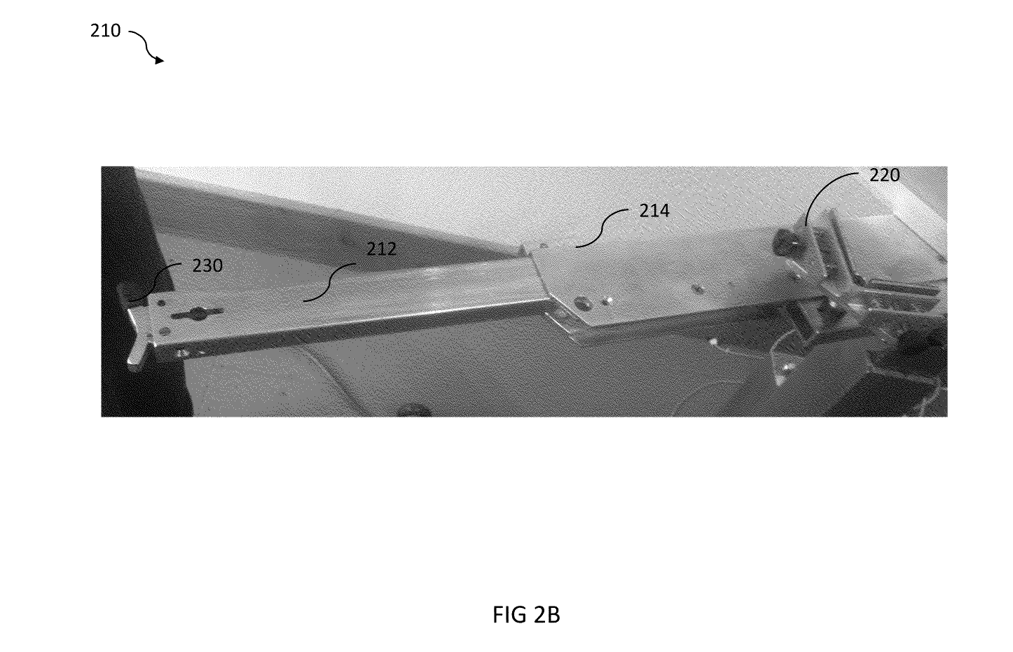

FIG. 2A depicts the attachment mechanism 110 of the rotatable easel 100. The attachment mechanism 110 may include two or more arms 210 that intersect with one another and act as a platform in which to locate a canvas. The arms 210 may include telescopic components, such as an inner arm component 212 located within an outer arm component 214, which slide relative to another in order to shorten or lengthen the arms 210. A grip 220, or holding piece, may be located at the ends of each of the arms 210, such as coupled to an end of the outer arm component 214, in order to receive and hold a canvas in place on or proximate to the arms 210 of the attachment mechanism 110. A release component 230 is also located at the ends of the arms 210 and coupled to the inner arm components 212 of the arms 210. The release component 230, when engaged, includes components (e.g., internal springs and/or clamps) that enable the inner arm component 212 of an arm 210 to move relative to the outer arm component 214 of the arm 210. When not engaged, the arm components are fixed and do not move relative to one another, maintaining the current length of the arm 210.

For example, FIG. 2B depicts an arm 210 of an attachment mechanism 110 in a shortened position. In order to dynamically change the length of the arm in order to receive and support a canvas of a certain size, the release component 230 of the arm 210 is engaged, and the inner arm component 212, coupled to the release component 230, is pulled away from the center of the attachment mechanism 110 where the arms 210 intersect. This movement causes the grip 220, coupled to the outer arm component 214, to move towards the center of the attachment mechanism 110, effectively shortening the arm 210 for the purposes of receiving a canvas.

[please provide any additional details, or other internal components, here]

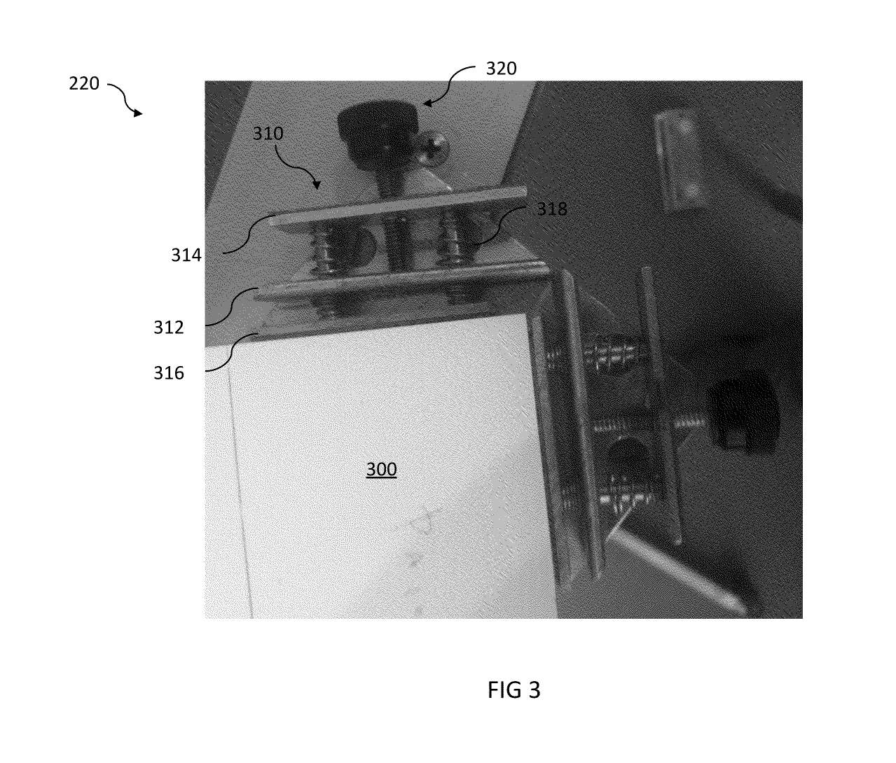

As described herein, the ends of an arm may include a grip 220 that receives and holds a canvas 300 or other object in place on the attachment mechanism 110. FIG. 3 depicts components of a grip 220. The grip 220 may include a receiving component 310 and a tightening component 320. The receiving component 310 includes a stop piece 316 that makes contact with a canvas 300 placed in the attachment mechanism 110. The stop piece 316 may be connected to adjustment pieces 312 and 314 via adjustment springs 318. The tightening component 320 (e.g., a knob, screw, and so on), is coupled to one or more of the adjustment pieces 312 and 314, and, when engaged, applies pressure to the stop piece 310 via the adjustment pieces 312 and 314 and the adjustment springs 318.

Each of the springs 318 may have different spring constants, enabling the grip to adjust the amount of pressure applied to a canvas within the attachment mechanism, in order to maintain the canvas within the attachment mechanism without damaging or otherwise compromising the structural integrity of the canvas when pressure is applied.

The grip 320 may be rotatably fixed to the outer arm component 314 of an arm 310 in order to easily and efficiently receive the canvas at a grip 220 via the stop pieces 316. Thus, when placing a portion of a canvas 300 near a grip 220, a user may rotate the grip 220 slightly to engage the canvas 300, and then tighten the tightening component 320 in order to secure the canvas to the grip via the stop piece 316.

Thus, the attachment mechanism, in some examples, includes arms that are configured to support many different sized canvasses. For example, the canvas attachment mechanism may be configured to include a first arm adjusted to a first length and a second arm adjusted to a second length different than the first length.

Therefore, in some examples, a simple action of engaging a release component, one or both arms may be resized to receive a canvas, and grip components may then be placed and/or located at the edges or corners of the canvas to maintain the canvas in placed on or within the easel. The canvas may then be oriented in any position within three-dimensional space in front of an artist or other viewer.

Of course, one of ordinary skill in the art will realize that the apparatus described herein may be utilized to support a variety of different two-dimensional, or relatively two-dimensional objects. For example, the apparatus described herein may be modified to support and/or position displays and other screen type devices (e.g., flat panel TVs, laptops, tablet computers, and so on), signs or other information objects, instruments (e.g., drums, keyboards, xylophones, and so on), and other objects.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the system provided herein can be applied to other apparatuses, not necessarily the apparatus described above. The elements and acts of the various embodiments described above can be combined to provide further embodiments.

These and other changes can be made to the system in light of the above Detailed Description. While the above description details certain embodiments of the apparatus and describes the best mode contemplated, no matter how detailed the above appears in text, the system can be practiced in many ways. As noted above, particular terminology used when describing certain features or aspects of the apparatus should not be taken to imply that the terminology is being redefined herein to be restricted to any specific characteristics, features, or aspects of the apparatus with which that terminology is associated. In general, the terms used in the following claims should not be construed to limit the apparatus to the specific embodiments disclosed in the specification, unless the above Detailed Description section explicitly defines such terms. Accordingly, the actual scope of the apparatus encompasses not only the disclosed embodiments, but also all equivalent ways of practicing or implementing the apparatus under the claims.

We claim:

1. An apparatus for positioning a two-dimensional object in three-dimensional space, the apparatus comprising:
a base;
a support beam coupled to the base and configured to translate in a vertical direction; and
an attachment mechanism coupled to the support beam, wherein the attachment mechanism includes:
two size-adjustable arms that intersect one another to form a platform in which to place a two-dimensional object; and
grip components located at the ends of each of the two size-adjustable arms, wherein the grip components are rotatably fixed to the arms and configured to make contact with the two-dimensional object in order to maintain the two-dimensional object at the platform formed by the two size-adjustable arms.

2. The apparatus of claim 1, further comprising:
a motor coupled to the support beam and configured to cause the support beam to move in an upwards or downwards direction.

3. The apparatus of claim 1, wherein the attachment mechanism is coupled to the support beam via an orientation component that enables the attachment mechanism to rotate about the support beam.

4. The apparatus of claim 1, wherein the attachment mechanism is coupled to the support beam via an orientation component that enables the attachment mechanism to rotate about the support beam and rotate about an axis perpendicular to an axis parallel to the support beam.

5. The apparatus of claim 1, wherein each of the two size-adjustable arms that intersect one another to form a platform in which to place a two-dimensional object include:
an outer arm component coupled to the grip components;
an inner arm component located within the outer arm component and coupled to a release component; and
wherein the inner arm component is capable of moving with respect to the outer arm component when the release component is engaged.

6. The apparatus of claim 1, wherein the grip components each include:
a stop piece configured to contact the two-dimensional object;
one or more adjustment components configured to apply pressure to the stop piece; and
a tightening component configured to cause the one or more adjustment components to apply the pressure to the stop piece.

7. An easel, comprising:
a canvas attachment mechanism having two or more intersecting arms that provide a platform in which to locate a canvas, wherein the two or more arms include components configured to adjust a size of one or more of the two or more intersecting arms; and
a canvas orientation component coupled to the canvas attachment mechanism configured to enable the canvas attachment mechanism to move in three-dimensional space order to maintain the canvas in a predetermined position.

8. The easel of claim 7, further comprising:
a stand; and
a support beam coupled at one end to the stand and at another end to the canvas attachment mechanism via the canvas orientation component, wherein the support beam is configured to move the canvas attachment mechanism in a vertical direction.

9. The easel of claim 7, wherein the canvas attachment mechanism is configured to include a first arm adjusted to a first length and a second arm adjusted to a second length different than the first length.

10. An object positioning apparatus, comprising:
a support beam; and
an attachment mechanism coupled to and supported in three-dimensional space by the support beam, wherein the attachment mechanism includes two or more intersecting arms configured to maintain objects of different sizes within the three-dimensional space.

11. The object positioning apparatus of claim 10, wherein the attachment mechanism may have a configuration where a first arm of the attachment mechanism has a length different than a length of a second arm of the attachment mechanism.
